(19) United States
(12) Patent Application Publication
(10) Pub. No.: US 2002/0017353 A1
(43) Pub. Date: Feb. 14, 2002

(54) Automotive Tire

(75) Inventor: Toru Nirei, Saitama (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: HONDA GIKEN KOGYO KABUSHIKI KAISHA, Tokyo (JP)

(21) Appl. No.: 09/910,067

(22) Filed: Jul. 23, 2001

(30) Foreign Application Priority Data
Aug. 7, 2000 (JP) P.2000-238008

(51) Int. Cl. B60C 9/02

(52) U.S. Cl. 152/564

(57) ABSTRACT

The external surface of a tire 1 except for a tread surface 9 thereof or the external surfaces of shoulder portions 12 and side portions 10 of the tire 1 are covered with a coating 13 formed from fluorine rubber which makes difficult the transmission of HC.

### BACKGROUND OF THE INVENTION

1. Field of the Invention

The present invention relates to a tire for use on vehicles such as automotive vehicles.

2. Description of the Related Art

There is a tendency that the control over the emission of toxic gases from automotive vehicle is getting severer from a viewpoint of protection of environment, and in particular, efforts are made to alter the related regulations so as to legislate the zero emission of hydrocarbon (HC).

Various countermeasures have been taken to reduce the amount of hydrocarbon emitted from automotive vehicles. However, those countermeasures have centered mainly on how to reduce the amount of HC emitted from engines of automotive vehicles.

However, not all HC that is emitted from automotive vehicles is emitted only from the engines.

According to studies carried out by the inventor of the present invention, it has been found that a large amount of HC is emitted from parts of an automotive vehicle other than the engine. Furthermore, as to HC emitted from the other parts than the engine, it has been found that the tires (including a spare tire) are a source of the emission of the greatest amount of HC, amounting to about 40% of the total emission of HC from the automotive vehicle except for the engine.

Consequently, in order to reduce the amount of HC emitted from vehicles such as automotive vehicles further, it is effective to suppress the emission of HC from the tires.

However, no specific countermeasures has been taken to reduce the amount of HC emitted from tires.

### SUMMARY OF THE INVENTION

The invention was made in view of these circumstances, and an object thereof is to suppress the emission of HC from the tires to thereby reduce the total amount of HC emitted from an automotive vehicle.

In addition, another object of the invention is to eliminate any risk of the performance of the tire being affected by a countermeasures so taken.

With a view to attaining the objects, according to the invention, the external surface of a tire except for a tread surface thereof is covered with a coating providing a low transmission of HC or more preferably a coating providing a zero transmission of HC. Raised as examples of such coatings are nylon coatings and fluorine rubber coatings.

According to the construction described above, about 60 to 70% of the total exposed rubber portion of a tire mounted on a wheel is covered with a coating which makes difficult the transmission of HC therethrough. In addition, since HC is emitted from the exposed rubber portions of the tire, the 60 to 70% coverage with the coating helps reduce the amount of HC emitted from the tire remarkably.

Moreover, since the coating is not applied to a tread surface of the tire which constitutes a contact surface with the road surface, there is caused no risk of the running performance of vehicles being affected by the coating. Furthermore, the coating to be applied may be thin, and coating having almost the same resiliency as that of tires can easily be obtained, this reducing a risk of the resiliency of tires being affected.

### BRIEF DESCRIPTION OF THE DRAWINGS

FIG. 1 is a cross-sectional view of an embodiment of an automotive tire according to the invention.

### DETAILED DESCRIPTION OF THE PREFERRED EMBODIMENTS

Referring to the accompanying drawings, an embodiment of the invention will be described below.

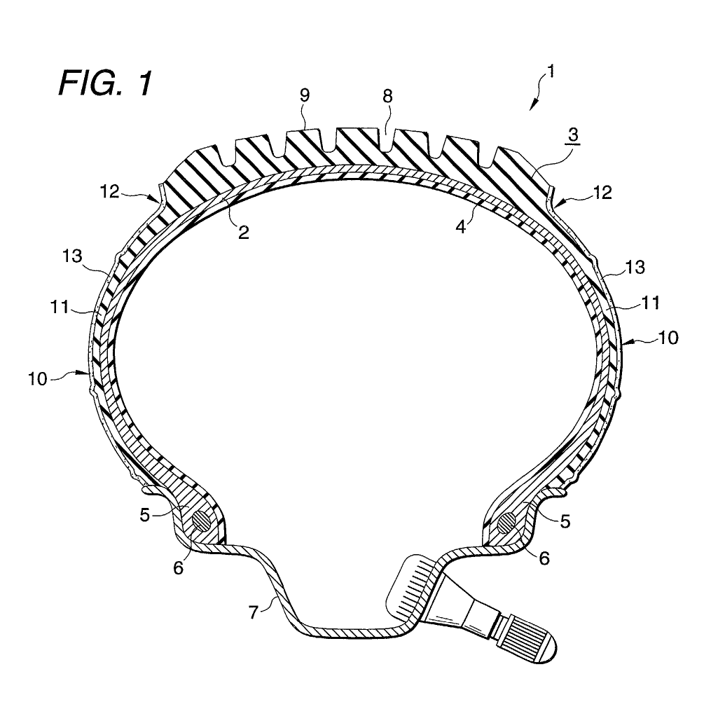

As is clear from FIG. 1, a tire is a tubeless tire and includes a carcass 2 as a member for providing strength, and a rubber covering layer 3. A rubber-layered inner liner 4 is applied on the inner surface of the carcass 2. Bead wires 6 are embedded in proximal portions or bead portions 5 of the tire 1, and the bead portions 5 is fitted into a rim 7 of the wheel, whereby the tire 1 is fixed to a wheel.

The rubber covering layer 3 is made thicker at a crown portion 8 of the tire 1, and an outer surface of the crown portion 8 is formed as a tread surface 9 adapted to be brought into contact with the road surface. In addition, the rubber covering layer 3 is made thinner at side portions 10 on sides of the tire 1, as thin side walls 11. The thickness of the rubber covering layer 3 at shoulder portions 12 contiguous with the crown portion 8 is made to be reduced gradually toward the side portions 10.

A thin coating 13 is formed on the external surface of the rubber covering layer 3 constituting the shoulder portions 12 and the side portions 10 of the tire 1 by coating fluorine rubber to those portions. Namely, the external surface of the tire 1 where rubber is exposed except for the tread surface 9 is totally covered with the coating 13 comprising the fluorine rubber. The coating 13 of fluorine rubber has a feature that no HC is transmitted through the coating 13.

With the tire 1 constructed as described above, even if HC is generated from the rubber covering layer 3 due to the effect of heat generated while the vehicle is running or ultraviolet rays, since the shoulder portions 12 and the side portions 10 are covered with the coating 13 which allows the transmission of no HC, the emission of HC from the shoulder portions 12 and the side portions 10 is totally prevented. The total area of the shoulder portions 12 and the side portions 10 amounts to 60 to 70% of the total external surface of the rubber covering layer 3 of the tire 1. Then, since about 40% of the HC emission from the parts other than the engine comes from the tires, eventually about 30% of the HC emission from the parts other than the engine is suppressed by the coating 13.

On the other hand, no coating is applied to the tread surface 9 of the tire 1 which contacts the road surface, and rubber is left exposed on the tread surface 9. Thus, no friction properties of the tire with the road surface is affected. In addition, since the coating 13 only has to prohibit the transmission of HC, the coating 13 may be thin, and the coating 13 formed by coating the fluorine rubber has the quality of rubber, and when compared with the rubber covering layer 3 of the tire 1, the coating 13 provides almost the same resiliency as that of the rubber covering layer 3 of the tire 1. Therefore, the effect to the resiliency of the tire 1 is very limited. Consequently, even if the coating 13 constructed as described above is applied to the tire 1, there is caused no risk of the running performance of vehicles being affected thereby.

Thus, while the embodiment of the automotive tire according to the invention has been described specifically with reference to the accompanying drawing, the invention is not limited thereto. For example, in the embodiment, while the coating 13 is described as one formed of the fluorine rubber coating, a nylon coating may instead be used. Although not to the extent provided by fluorine rubber, nylon is also a material which makes difficult the transmission of HC, whereby almost the same effect as that obtained with the fluorine rubber coating can be obtained.

In addition, the coating 13 may be extended as far as external surface areas of the bead portions 5 which are contiguous with the side wall portions.

Furthermore, while the invention has been described as being applied to the tubeless tire, the invention may be applied to tube tires or tires for buses and trucks.

As is clear from what has been described heretofore, according to the invention, since most of the external surface areas of the tire where rubber is exposed is covered with the coating which makes difficult the transmission of HC, the amount of HC emitted from the tire can be reduced remarkably. Then, since HC emitted from the tire occupies a large portion of HC emitted from the parts other than the engine, the amount of HC emitted from the whole of the vehicle can be reduced to a large extent by the application of the coating.

Moreover, since no such coating is applied to the tread surface which is the contact surface of the tire with the road surface, there is caused no risk of the friction properties of the tire with the road surface being affected by the coating. In addition, since the coating may be thin, the effect to the resiliency of the tire by the coating can be limited remarkably.

What is claimed is:

1. An automotive tire wherein an external surface of the tire except for a tread surface is covered with a coating which makes difficult the transmission of hydrocarbon therethrough.

2. An automotive tire comprising:
a rubber covering layer defining a tread surface of the tire; and
a coating covering an external surface of said rubber covering layer other than the tread surface, said coating making difficult the transmission of hydrocarbon therethrough.

3. The automotive tire according to claim 2, wherein said coating is a fluorine rubber coating.

4. The automotive tire according to claim 2, wherein said coating is a nylon coating.

5. The automotive tire according to claim 2, wherein said coating covers the external surface of said rubber covering layer at side portions on sides of the tire and shoulder portions between the tread surface and the side walls.
